(19) United States
(12) Patent Application Publication
(10) Pub. No.: US 2011/0168863 A1
(43) Pub. Date: Jul. 14, 2011

(54) Foldable Instrument Stand

(76) Inventor: Brenton Spencer Tregloan, Highbury (AU)

(21) Appl. No.: 13/021,779

(22) Filed: Feb. 6, 2011

(30) Foreign Application Priority Data
Jan. 12, 2010 (AU) 2010900558

(51) Int. Cl. F16M 11/38

(52) U.S. Cl. 248/435

(57) ABSTRACT

An instrument stand includes a first frame member hingedly engaged with a second frame member; a first strut member hingedly attached to the first frame member; a second strut member hingedly attached to the second frame member; and a pair of elongate foot members respectively attached to the first frame member and the second frame member, each elongate foot member being pivotally attached to the respective frame member. The first strut member is hingedly attached to the second strut member.

### FIELD OF INVENTION

The disclosed invention relates to a stand for holding a musical instrument. Specifically, the disclosed invention relates to a stand for holding a musical instrument, and which stand is adapted for compact storage, simple assembly/disassembly, and stability.

### BACKGROUND

Musical instruments are routinely taken onto a performance stage, where they are held on instrument stands. Conventional instrument stands are foldable, but tend to be heavy and/or require several steps to assemble and disassemble. Moreover, conventional instrument stands generally do not disassemble into a flat package, nor into a form factor that facilitates storage and transport preferably together with the instrument within the instrument case, and/or in a small carry bag.

Conventional instrument stands further tend to be structured as a tripod, where the weight of the stand, and hence also the instrument supported thereon, rests on three points in contact with the floor/ground. Whilst a tripod structure ensures a secure foundation even on uneven surfaces, the tripod structure is prone to tipping over when knocked.

There exists a need for an instrument stand that can be simply and easily assembled/disassembled, and which is light weight, foldable, compact, and stable.

### SUMMARY

According to an aspect of the present disclosure, an instrument stand comprises a first frame member hingedly engaged with a second frame member; a first strut member hingedly attached to the first frame member; a second strut member hingedly attached to the second frame member; and a pair of elongate foot members respectively attached to the first frame member and the second frame member, each elongate foot member being pivotally attached to the respective frame member. The first strut member is further hingedly attached to the second strut member.

### DESCRIPTION OF DRAWINGS

FIG. 1 illustrates an instrument stand, according to one embodiment of the present invention, in an unfolded state.

FIG. 2 illustrates an A-frame of an instrument stand in an unfolded state, according to one embodiment of the present invention.

FIG. 3 illustrates an A-frame of an instrument stand in a transition state, according to one embodiment of the present invention.

FIG. 4 illustrates an instrument stand, according to one embodiment of the present invention, in a folded state.

FIG. 5 illustrates an instrument stand, according to another embodiment of the present invention.

### DETAILED DESCRIPTION

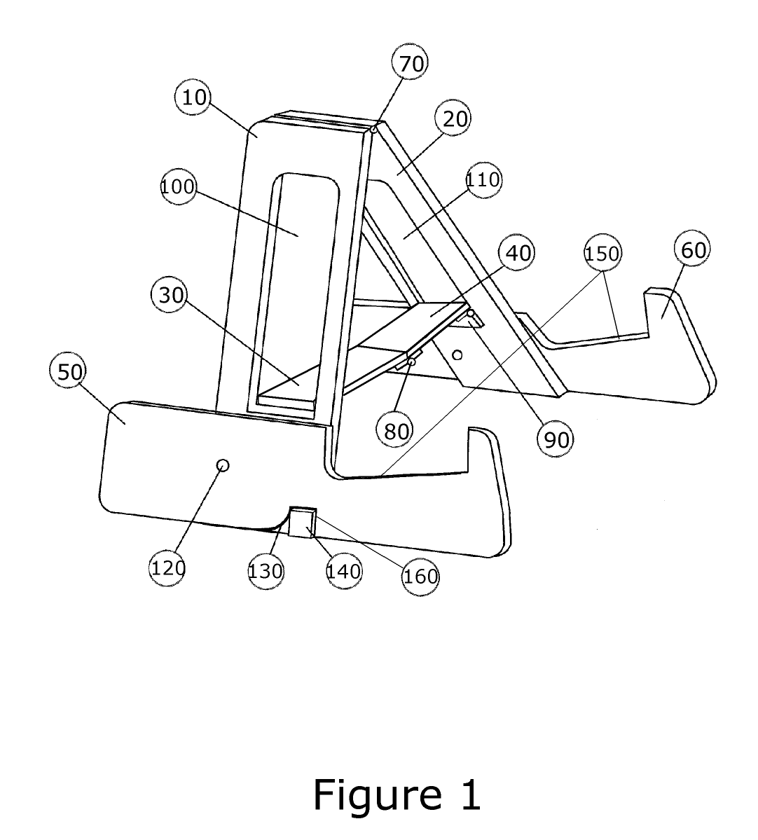

FIG. 1 illustrates an instrument stand according to a first embodiment of the present invention. The instrument stand includes a core A-Frame formed by first and second frame members 10, 20 and a pair of sled feet 50, 60. In use, an instrument such as a guitar, violin, and the like, is supported in an upright orientation on the sled feet 50, 60 of the instrument stand.

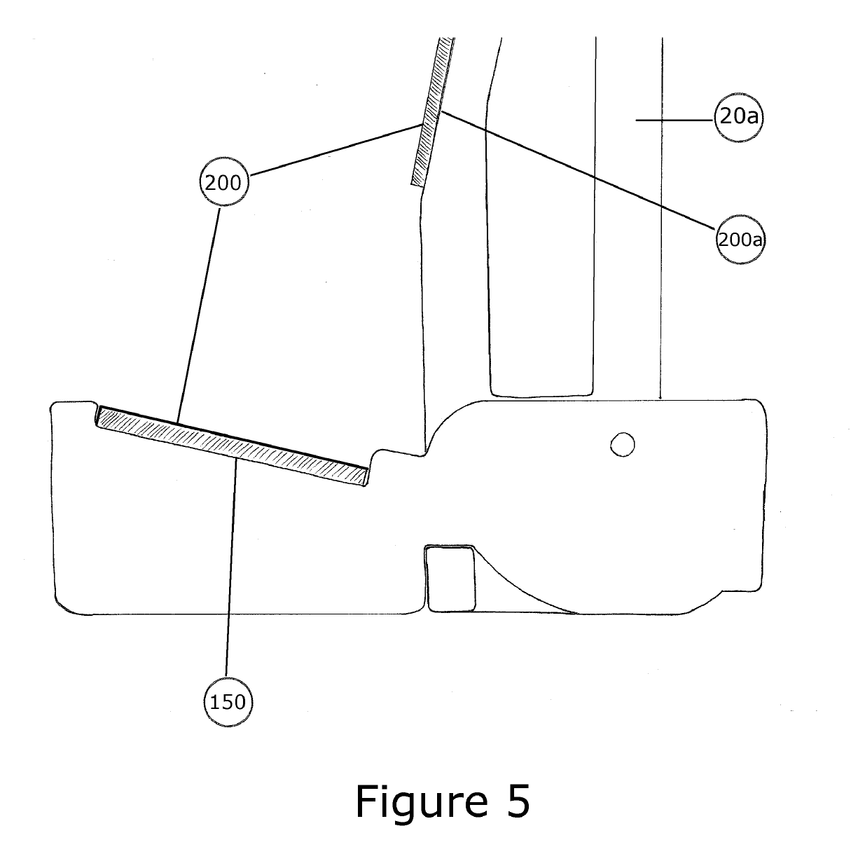

An upper edge of each sled foot 50, 60 of the instrument stand is defined with a holding recess 150 for holding a base of the instrument securely on the sled feet 50, 60. An edge each recess 150 is preferably lined with a soft and/or resilient material 200 (see FIG. 5), such as foam, rubber, and the like to protect an instrument supported on the instrument stand and/or to provide sufficient friction to maintain the instrument on the stand despite the application of accidental destabilizing forces thereto. A bottom edge of each sled foot 50, 60 is provided with a locking notch 160 for engaging with a corresponding locking mechanism 140 provided on each frame member 10, 20 of the core A-frame. Each sled foot 50, 60 is respectively attached to the first and second frame members 10, 20 by an attachment pin 120. The attachment pin 120 secures each sled foot 50, 60 to its respective frame member 10, 20, and further acts as a pivot point 120 about which each sled foot 50, 60 may pivot. In an unfolded state, each sled foot 50, 60 extends both forward and rearward of the core A-frame.

In one aspect of the first embodiment, the locking mechanism 140 is a block protruding from a respective frame member 10, 20, and over which the locking notch 160 defined in corresponding sled feet 50, 60 fit. Gravity and/or the weight of the instrument supported on the sled feet 50, 60 serves to hold the locking notch 160 down over the protruding block 140, thereby locking the sled feet 50, 60 in place.

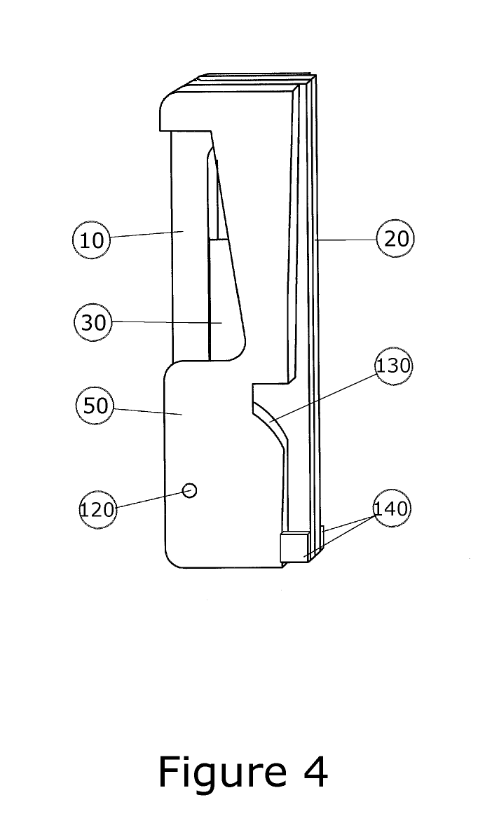

The bottom edge of each sled foot 50, 60 in the vicinity of the locking notch 160 is shaped (see element 130) to provide sufficient clearance between the sled foot 50, 60 and the protruding blocks 140, to allow the sled foot 50, 60 to freely pivot about the attachment 120 pin between an unfolded position (as shown in FIG. 1) and a folded position (as shown in FIG. 4).

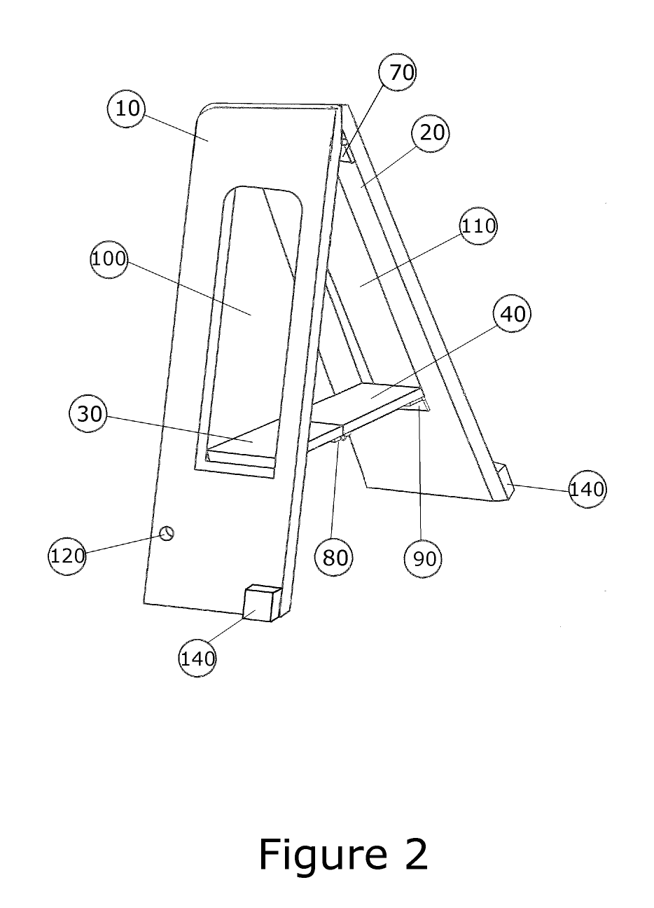

Referring to FIG. 2, a structure of the core A-frame is described in greater detail. The first frame member 10 and the second frame member 20 of the core A-frame are hinged together by a top hinge 70 to form the apex of the core A-frame. The top hinge 70 preferably has a limited range of extension to limit a distance that the first frame member 10 may be rotated/unfolded from the second frame member 20 about the apex of the core A-frame.

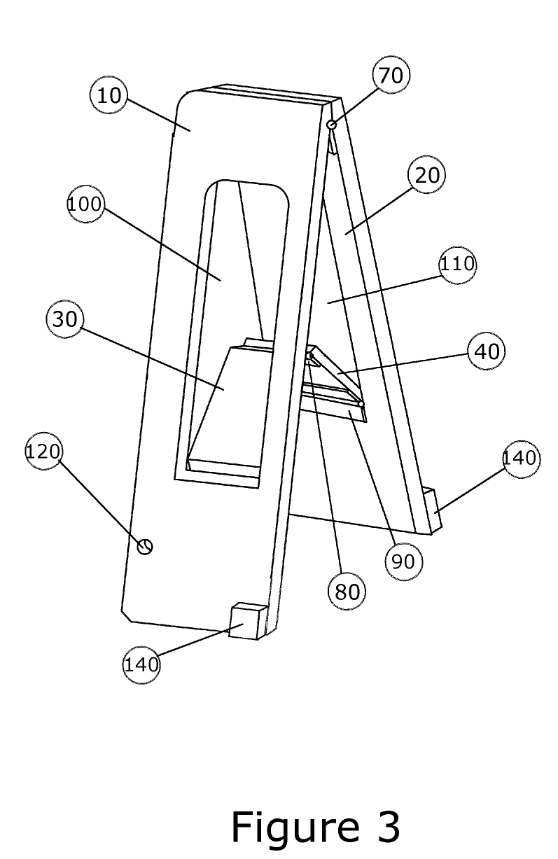

The core A-frame further has a strut member 30, 40 extending between the first frame member 10 and the second frame member 20. The strut member 30, 40 is made up of a left strut half-member 30 and a right strut half-member 40. The left strut half-member 30 is attached to the first frame member 10 via a left strut hinge, and the right strut half-member 40 is similarly attached to the second frame member 20 via a right strut hinge 90. The left strut half-member 30 and the right strut half-member 40 are attached to each other via a centre strut hinge 80. The centre strut hinge 80 is configured to allow the left strut half-member 30 and the right strut half-member 40 to hinge towards an apex of the core A-frame, as shown in FIG. 3.

Assuming that the angle between the left strut half-member 30 and the right strut half-member 40 when the core A-frame is in the folded position (as illustrated in FIG. 4) is considered to be 0°, the centre strut hinge 80 is configured to have a limited range of rotation preventing the hinge 80 from unfolding significantly past a maximum angle of around 250°. Preferably, the hinge 80 allows the left strut half-member 30 and the right strut half-member 40 to unfold to an angle past 180° but no further than about 225° when the core A-frame is in the unfolded position. In doing so, the left strut half-member 30 and the right strut half-member 40 angle towards the ground at the centre strut hinge 80, thereby locking the core A-frame in an unfolded position. In the unfolded position, the upper portions of the first and second frame members 10, 20 and the right and left strut half-members 30, 40 form a convex quadrilateral locked in place by the centre hinge 80 which prevents unfolding of the left and right strut half-members 30, 40 past the maximum angle.

In the event of a lateral force being applied to either of the first frame member 10 or the second frame member 20, the lateral force is transferred to the left and/or right strut half-members 30, 40 and directed downwards away from the apex of the core A-frame. The applied force and the reflex angle (i.e. >180°) arrangement of the right and left strut half-members 30, 40 encourage the right and left strut half-members 30, 40 to fold together in a manner where the left strut half-member seeks to move clockwise, while the right strut half-member seeks to move counter-clockwise (as viewed from front-side of the stand, where the instrument is supported). However, the folding of the right and left strut half-members 30, 40 is prevented by the centre strut hinge 80 having been adapted to limit rotation past the maximum angle (e.g. 225°). Accordingly, the lateral force is absorbed allowing the core A-frame to maintain its form and structure.

Both the first frame member 10 and the second frame member 20 have defined therethrough respective first and second frame apertures 100, 110. The first and second frame apertures 100, 110 each have a width of at least that of the left and right strut half-members 30, 40, and extend from a point of attachment of the left and right strut half-members 30, 40 with respective first and second frame members 10, 20 towards the apex of the core A-frame. The length of the first and second frame apertures 100, 110 is at least that of the first and second strut half-members 30, 40 and may be more.

An edge of the first and second frame members 10, 20 on which an instrument supported in the instrument stand rests is, similar to the sled feet 50, 60, lined with a soft and/or resilient material 200 (see FIG. 5) such as foam, rubber, and the like, to protect the instrument and/or to provide sufficient friction to maintain the instrument on the stand despite the application of accidental destabilizing forces thereto.

FIG. 4 illustrates the instrument stand in a folded state suitable for storage and transport. In the folded state, the sled feet 50, 60 are pivoted about their respective attachment pins 120 into the position illustrated. The shape of the lower edge (as indicated by element 130) of each sled foot 50, 60 allows each foot to be pivoted without interference from the locking mechanism 140. In this position, the sled feet 50, 60 fit within a planar foot print of the first and second frame members 10, 20. Further, the left strut half-member 30 is received into the first frame aperture 100 of the first frame member 10, and the right strut half-member 40 is similarly received into the second frame aperture 110 of the second frame member 20. The overall thickness of the instrument stand when in the folded state is hence little more than the combined thickness of the two sled feet 50, 60 and the two frame members 10, 20. The folded state of the instrument stand presents a compact and sturdy package that facilitates storage and transport of the instrument stand, particularly storage and transport within an instrument case, and/or small carry bag.

An assembling and disassembling operation of the instrument stand is described with reference to FIGS. 1 to 4, beginning from the folded state of the instrument stand illustrated in FIG. 4.

With the instrument stand in the folded state depicted in FIG. 4, the sled feet 50, 60 are preferably first pivoted downwards about the attachment pins 120 such that the locking notch 160 of each sled foot 50, 60 engages with the locking mechanism 140 of a respective frame member 10, 20. Subsequently, the first frame member 10 and the second frame member 20 are pulled apart to form the core A-frame.

As the first frame member 10 and the second frame member 20 are pulled apart, the left strut half-member 30 and the right strut half-member 40 are similarly pulled apart, as shown in FIG. 3. When the centre hinge 80 unfolds to its maximum extension of around 180° to 225° further separation of the first frame member 10 and the second frame member 20 is prevented. In this position, the force of gravity acting on the left and right strut half-members 30, 40 and the locking of the centre hinge 80 at its maximum angle/extension of around 180° to 225° securely maintains the structure and shape of the core A-frame. A convex quadrilateral is formed by the upper portions of the first and second frame members 10, 20 and the left and right strut half-members 30, 40. It should be understood that the sled feet 50, 60 may alternatively be pivoted into operational position after the core A-frame is formed.

To disassemble the instrument stand, the core A-frame is preferably first collapsed by applying a force on the centre hinge 80 directed towards the apex of the core A-frame. Application of a force on the centre hinge 80 breaks the quadrilateral formed by the upper portions of the first and second frame members 10, 20 and the left and right strut half-members 30,40. Accordingly, the left and right strut half-members 30, 40 fold towards each other, thereby also folding the first frame member 10 and the second frame member 20 towards each other. As the first and second frame members 10, 20 fold towards each other, the left strut half-member 30 is received into the first frame aperture 100 of the first frame member 10, and the right strut half-member 40 is similarly received into the second frame aperture 110 of the second frame member 20.

With the first and second frame members 10, 20 folded flat against each other (i.e. with the centre hinge 80 at 0°), and the left and right strut half-members 30, 40 received into respective frame apertures 100, 110 the sled feet 50, 60 are then pivoted upwards about the attachment pin 120 such that each foot is lengthwise parallel with the first and second frame members 10, 20, as illustrated in FIG. 4. It should be understood that the sled feet 50, 60 may alternatively be pivoted into their storage position before the core A-frame is collapsed.

The instrument stand of the present disclosure allows fully assembly and disassembly in just two steps. Namely, the hinging or unhinging of the centre hinge 80, and the rotation of the sled feet 50, 60 between their folded state and their unfolded state.

As the sled feet 50, 60 of the instrument stand extend both forward and rearward of the core A-frame, the sled feet 50, 60 form a substantially rectangular base/footprint for the instrument stand. Accordingly, the stability of the instrument stand of the present disclosure is substantially improved as compared to conventional tripod-style instrument stands.

Still further, the sled feet 50, 60 distribute the weight of the instrument supported on the instrument stand over the entire length of both feet 50, 60 instead of concentrated at three individual points as in the case of a tripod-style instrument stand. This allows the instrument stand of the present disclosure to more easily slide across the surface it rests on if accidentally knocked, rather than tip over. As the vast majority of stages on which musical instruments are brought are flat, there is no substantial disadvantage in the sled feet 50, 60 arrangement of the present invention compared to the tripod arrangement of conventional instrument stands.

FIG. 5 illustrates a second embodiment of the instrument stand of the present disclosure. The instrument stand of the second embodiment employs frame members 20a, having a sloping edge 200a on which a back of an instrument supported thereon rests. The sloping edge 200a better facilitates the stable positioning of the instrument on the instrument stand.

FIG. 5 further illustrates the soft and/or resilient material 200 provided on the holding recess 150 of the sled feet, and on the sloping edge 20a. The soft and/or resilient material 200 illustrated in FIG. 5 are the same as those used in the first embodiment, and provided in like positions.

The operation of the instrument stand according to the second embodiment is identical to that of the first embodiment.

The instrument stand of the present disclosure is preferable constructed of a light but rigid materials. Suitable materials include wood, plastic, carbon fibre, aluminium, and Perspex. The instrument stand may also be designed as a one-use, disposable type stand, constructed from materials having only short-term rigidity, such as cardboard, foam, and the like.

The instrument stand of the present disclosure is sized in accordance with the type of instrument designed to be supported thereon. An instrument stand for a violin or mandolin is, for example, approximately ⅔ to ¾ the size of an instrument stand for a guitar and banjo.

Although the invention has been described herein with reference to a number of specific embodiments, it will be appreciated by those skilled in the art that the invention is not limited only to the disclosed embodiments, and that these embodiments described a best-mode/preferred embodiment, whereas the invention may be embodied in other forms encompassed within the scope of this invention.

1. An instrument stand, comprising:
a first frame member hingedly engaged with a second frame member;
a first strut member hingedly attached to the first frame member;
a second strut member hingedly attached to the second frame member; and
a pair of elongate foot members respectively attached to the first frame member and the second frame member, each elongate foot member being pivotally attached to the respective frame member, wherein
the first strut member is hingedly attached to the second strut member.

2. The instrument stand according to claim 1, wherein each elongate foot member is adapted to pivot between a storage position and an operational position.

3. The instrument stand according to claim 1, wherein the hinged attachment of the first strut member with the second strut member has a limited angle of rotation.

4. The instrument stand according to claim 3, wherein the first frame member, the second frame member, the first strut member, and the second strut member form a convex quadrilateral at the maximum angle of rotation of the first strut member with the second strut member.

5. The instrument stand according to claim 1, wherein the first frame member defines a first recess sized to received therein the first strut member, and the second frame member defines a second recess sized to received therein the second strut member.

6. The instrument stand according to claim 2, wherein each elongate foot in the operational position extends past a respective frame member on two sides of the respective frame member.

7. The instrument stand according to claim 3, wherein the hinged attachment of the first strut member to the second strut member facilitates a folding of the first strut member towards the second strut member.

8. The instrument stand according to claim 7, wherein the folding of the first strut member towards the second strut member folds the first frame member towards the second frame member.

9. The instrument stand according to claim 8, wherein the first strut member is received in the first recess and the second strut member is received in the second recess, when the first frame member is folded against the second frame member.

10. The instrument stand according to claim 2, further comprising a locking block attached to each of the first frame member and the second frame member.

11. The instrument stand according to claim 10, wherein each of the foot members defines a locking notch adapted to engage with a respective locking block.

12. The instrument stand according to claim 11, wherein the locking notch is held in engagement with the locking block by gravity and by a weight of an instrument supported on the instrument stand.

13. The instrument stand according to claim 10, wherein a lower edge of each foot member is shaped to facilitate the pivoting of each foot member between the storage position and the operational position in a manner free from interference by the locking block.

14. The instrument stand according to claim 1, wherein an upper edge of each foot member is shaped to define a recess adapted to receive therein an instrument.

15. The instrument stand according to claim 14, further comprising a soft and resilient material lining the recess.

16. The instrument stand according to claim 1, further comprising a soft and resilient material lining an edge of the first and second frame members.

17. The instrument stand according to claim 1, wherein one edge of each of the first and second frame members is sloped, whereby an instrument supported by the instrument stand is positioned away from the perpendicular.

18. The instrument stand according to claim 1, wherein the first frame member, the second frame member, the first strut member, the second strut member, and each foot member is made of one or more rigid material selected from the group consisting of: wood, Perspex, plastics, aluminium, and glass.

19. The instrument stand according to claim 2, wherein, in the storage position, each foot member is substantially parallel to a respective frame member.

20. The instrument stand according to claim 2, wherein, in the operational position, each foot member is substantially perpendicular to a respective frame member.
